(19) United States
(12) Patent Application Publication
(10) Pub. No.: US 2010/0110305 A1
(43) Pub. Date: May 6, 2010

(54) Method and Apparatus for Processing Multiple Broadcasting Signal Standards in a Broadcasting Signal Receiver System

(75) Inventors: Stephen H. Chou, Fremont, CA (US); Useng Iu, San Francisco, CA (US); Tao Yu, Fremont, CA (US)

Correspondence Address: Invent Capture, LLC, 3319 Foxtail Terrace, Fremont, CA, 94536, US

(73) Assignee: SOFTASIC, INC., Fremont, CA (US)

(21) Appl. No.: 12/265,739

(22) Filed: Nov. 6, 2008

(51) Int. Cl. H04N 5/455; H04N 5/50; H04N 7/12

(52) U.S. Cl. 348/726; 348/731; 375/240.01; 348/E05.113; 348/E05.097; 375/E07.076

(57) ABSTRACT

A broadcasting signal receiver system containing a multi-standard-compatible dedicated processing unit and a general system resource is disclosed, wherein the multi-standard-compatible dedicated processing unit is configured to process one or more tuning processing steps and/or one or more demodulation processing steps, and wherein the general system resource is configured to process at least one collaborative demodulation processing step with the multi-standard-compatible dedicated processing unit via a high-speed data transfer interface. By utilizing the general system resource for at least one demodulation processing step using the high-speed data transfer interface such as USB 3.0 or PCI Express, the broadcasting signal receiver system can have a flexible design for future updates and a cost-effective compatibility to a multiple number of broadcasting standards without requiring the dedicated processing unit to use more application-specific hardware resources.

### BACKGROUND

A concept of a personal computer (PC) being also used as a television (TV) existed since the 1980's, when the graphics capability of a personal computer became similar or superior to a standard analog resolution television set. In case of IBM-compatible PC's, a Video Graphics Array (VGA) or a Super-Video Graphics Array (SVGA) graphics card coupled with a PC monitor with VGA-level or higher resolutions were sufficient to display television signals on a PC. The PC's with TV tuner cards were sometimes called PC Televisions, or “PCTV”.

However, due to a relatively high cost of PC TV tuner cards, vendor-specific implementations of the PC TV tuner cards, a variety of broadcasting signal standards in different regions of the world, and several other factors, the PC TV tuner cards did not become de facto standard equipment in PC's and still remain as optional or aftermarket devices to a brand new PC.

With the launch of digital TV broadcasts around the world, a PCTV user can receive crisp and clear pictures via airwave, cable, satellite, and/or Internet-based television broadcasts. Furthermore, a PCTV can utilize a PC's existing storage as a digital video recorder (DVR) with no additional charges to a consumer. Moreover, the vendor-specific aftermarket nature of PC tuner cards gradually began to change when Microsoft introduced an XP Media Center edition several years ago, in part to encourage PCTV vendors to centralize their device-specific drivers. In addition, Microsoft's Windows Vista also includes many multimedia features useful for PCTV. Therefore, as digital broadcast continues to gain its ubiquitous presence in many parts of the world, one can expect that PC users will desire the PC tuner card as an inexpensive standard feature in a brand new computer.

However, integrating PCTV tuner card function as a standard PC feature has some significant logistics and cost-related drawbacks. First, there are several distinct digital broadcast standards used around the world which are not compatible to each other. For example, Europe uses “Digital Video Broadcasting”, or “DVB” standard, while North America uses “Advanced Television Systems Committee”, or “ATSC”. Furthermore, Japan uses its own “Integrated Services Digital Broadcasting,” or “ISDB” standard, while China uses its homegrown “Digital Multimedia Broadcast Terrestrial/Handheld,” or “DMB-TH” standard. In addition, there are cable and satellite broadcast standards such as QAM, DVB-C, and DVB-S. With a conventional PCTV tuner architecture, the varying broadcasting standards by region means that a PC manufacturer has to install a region-specific PCTV tuner card and/or a region-specific PCTV motherboard, which is likely to be a logistics nightmare. Furthermore, if the PC manufacturer wants to create an all region-compatible PCTV tuner card and/or an all-region-compatible PCTV motherboard, then the cost of providing PCTV as a standard equipment becomes too burdensome. These reasons have kept PCTV to remain mostly as an aftermarket product.

Similarly, due to an increasing ubiquity of digital TV broadcasts, built-in digital-tuner TV's, TV set-top boxes, and/or mobile electronic devices capable of receiving digital multimedia broadcasts, also provide crisp and clear pictures via airwave, cable, satellite, and/or Internet-based broadcasts. The built-in digital-tuner TV's, the TV set-top boxes, and/or the mobile electronic devices capable of receiving digital multimedia broadcasts also face the same regional incompatibility issues and cost/logistics issues for their manufacturers.

Therefore, it is highly advantageous to create a novel method and an apparatus for processing multiple broadcasting signal standards in a single broadcasting signal receiver system for both PCTV industry and standalone TV and set-top box industries.

### SUMMARY

A broadcasting signal receiver system configured to accommodate a multiple number of broadcasting signal standards is disclosed as an embodiment of the invention. The broadcasting signal receiver system comprises a multi-standard-compatible dedicated processing unit configured to process one or more tuner processing steps and/or one or more demodulation processing steps for an input signal from an input signal port unit, a general system resource containing a demodulation processing software configured to be loaded to a memory unit in the general system resource and configured to be executed on an instruction processing unit of the general system resource, wherein the demodulation processing software operating in the general system resource is configured to process at least one collaborative demodulation processing step among the one or more demodulation processing steps with the multi-standard-compatible dedicated processing unit via a high-speed data transfer interface, and the high-speed data transfer interface with a bidirectional data transfer speed sufficient to accommodate the at least one collaborative demodulation processing step between the multi-standard-compatible dedicated processing unit and the general system resource without causing a bottleneck delay in the one or more demodulation processing steps.

Furthermore, another broadcasting signal receiver system configured to accommodate a multiple number of broadcasting signal standards is also disclosed as an embodiment of the invention. This broadcasting signal receiver system comprises a multi-standard-compatible dedicated processing unit configured to process one or more tuner processing steps and/or one or more demodulation processing steps for an input signal from an input signal port unit, a general system resource containing a demodulation processing software configured to be loaded to a memory unit in the general system resource and configured to be executed on an instruction processing unit of the general system resource, wherein the demodulation processing software operating in the general system resource is configured to process at least one collaborative demodulation processing step among the one or more demodulation processing steps with the multi-standard-compatible dedicated processing unit via a high-speed data transfer interface, a tuner processing software configured to be loaded to the memory unit in the general system resource and configured to be executed on the instruction processing unit of the general system resource, wherein the tuner processing software operating in the general system resource is configured to process at least one collaborative tuner processing step among the one or more tuner processing steps with the multi-standard-compatible dedicated processing unit via the high-speed data transfer interface, and the high-speed data transfer interface with a bidirectional data transfer speed sufficient to accommodate the at least one collaborative demodulation processing step and/or the at least one collaborative tuner processing step between the multi-standard-compatible dedicated processing unit and the general system resource without causing a bottleneck delay in the one or more demodulation processing steps.

Moreover, a method for collaborative broadcasting signal processing by a broadcasting signal receiver system comprising a multi-standard-compatible dedicated processing unit and a general system resource is also disclosed as an embodiment of the invention. The method comprises steps of receiving a broadcasting signal via an input port unit of the broadcasting signal receiver system, using a tuner in the multi-standard-compatible dedicated processing unit and/or a software-based tuner in the general system resource to convert the broadcasting signal from a radio frequency (RF) to an intermediate frequency (IF), and using an on-chip demodulator in the multi-standard-compatible dedicated processing unit and/or a software-based programmable demodulator resident in a memory unit of the general system resource for processing demodulation of the broadcasting signal, wherein one or more demodulation steps are processed by a bidirectional collaboration between the on-chip demodulator and the general system resource using a high-speed data transfer interface.

### BRIEF DESCRIPTION OF DRAWINGS

FIG. 1 shows a general signal processing flow including signal demodulation and decoding for a broadcasting signal receiver system in accordance with an embodiment of the invention.

FIG. 2 shows a high-level logical conceptual configuration for a broadcasting signal receiver system operatively connected to an input signal port unit and a display screen in accordance with an embodiment of the invention.

FIG. 3 shows a more detailed logical conceptual configuration for a broadcasting signal receiver system in accordance with an embodiment of the invention.

FIG. 4 shows an example of a demodulation process flow in accordance with an embodiment of the invention.

FIG. 5 shows an example of a collaborative broadcasting signal demodulation by a multi-standard-compatible dedicated processing unit and a general system resource in accordance with an embodiment of the invention.

FIG. 6 shows an example of a broadcasting signal receiver system using a multi-standard-compatible dedicated processing unit operatively connected to a general system resource containing a multi-core instruction processing unit (e.g. a multi-core CPU, a multi-core digital signal processor, and etc.) or a multiple number of instruction processing units (e.g. a multiple number of CPU's, a multiple number of digital signal processor, and etc.) for collaborative broadcasting signal demodulation in accordance with an embodiment of the invention.

FIG. 7 shows a collaborative broadcasting signal processing method by a multi-standard-compatible dedicated processing unit and a general system resource in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of figures, procedures, logic blocks, processing, and/or other symbolic representations that directly or indirectly resemble an apparatus and a method for processing multiple broadcasting signal standards in a broadcasting signal receiver system. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order and do not imply any limitations in the invention.

In general, embodiments of the invention relate to broadcast signal processing at a broadcasting signal receiver system. More specifically, an embodiment of the invention relates to a method for processing multiple broadcasting signal standards in a single broadcasting signal receiver system by offloading at least some standard-specific tuning process and/or at least some standard-specific demodulation steps to a general system resource utilizing a software running on the general system resource's instruction processing unit (e.g. a CPU, a digital signal processor, and etc.). An example of a “general system resource” is a PC system resource including its CPU and a memory unit. Examples of broadcasting signal receiver systems include, but are not limited to, a PCTV tuner card operatively connected to a general system resource, a set-top box with a multi-standard-compatible dedicated processing unit and a general system resource, and an audio system with a multi-standard-compatible dedicated processing unit and a general system resource.

Furthermore, an embodiment of the invention relates to a collaborative broadcasting signal demodulation by a multi-standard-compatible dedicated processing unit and a general system resource operating a programmable demodulation processing software running on the general system resource's instruction processing unit (e.g. a CPU, a digital signal processor, and etc.) and a memory unit.

In addition, an embodiment of the invention relates to a collaborative broadcasting signal tuner processing by a multi-standard-compatible dedicated processing unit and a general system resource operating a programmable tuner processing software running on the general system resource's instruction processing unit (e.g. a CPU, a digital signal processor, and etc.) and a memory unit.

Yet another embodiment of the invention relates to a collaborative broadcasting signal processing by a multi-standard-compatible dedicated processing unit and a general system resource, wherein the general system resource utilizes a multi-core instruction processing unit (e.g. a multi-core CPU, a multi-core digital signal processor, and etc.) or a multiple number of instruction processing units (e.g. a multiple number of CPU's, a multiple number of digital signal processors, and etc.) to pipeline and/or parallel-process broadcasting signal-related tasks.

Furthermore, one objective of the invention is to provide a method and an apparatus for processing multiple broadcasting signal standards in a single broadcasting signal receiver system by offloading at least some standard-specific tuning process and/or at least some standard-specific demodulation steps to a general system resource utilizing a software running on the general system resource's instruction processing unit (e.g. a CPU, a digital signal processor, and etc.)

A further objective of the invention is to utilize a collaborative broadcasting signal processing by a multi-standard-compatible dedicated processing unit and a general system resource to create a cost-effective and easily-updatable broadcasting signal receiver system which can handle a multiple number of broadcasting signal standards flexibly.

Yet another objective of the invention is to provide a collaborative broadcasting signal processing by a multi-standard-compatible dedicated processing unit and a general system resource, wherein the general system resource utilizes a multi-core instruction processing unit (e.g. a multi-core CPU, a multi-core digital signal processor, and etc.) or a multiple number of instruction processing units (e.g. a multiple number of CPU's, a multiple number of digital signal processors, and etc.) to pipeline and/or parallel-process broadcasting signal-related tasks.

For the purpose of describing the invention, a term “multi-standard-compatible dedicated processing unit” is defined as a specialized device configured to perform at least some broadcast signal demodulation and/or tuner processing in collaboration with a programmable tuner processing and/or demodulation software resident in a memory unit of a general system resource.

Furthermore, for the purpose of describing the invention, a term “general system resource” is defined as a general-purpose resource for a particular electronic system, wherein the general-purpose resource is not specifically designed to specialize in processing broadcast signals, and wherein the general-purpose resource is configured to be used by a multiple number of hardware and/or software associated with the particular electronic system.

Moreover, for the purpose of the describing the invention, a term “broadcasting signal receiver system” is defined as a collaborative broadcast signal processing system comprising a multi-standard-compatible dedicated processing unit and a general system resource, wherein the collaborative broadcast signal processing system is configured to perform one or more steps of tuner processing and/or one or more steps of signal demodulation collaboratively by requesting the general system resource to perform at least one tuner processing step and/or at least one signal demodulation step using a high-speed data transfer interface.

In addition, for the purpose of describing the invention, a term “input signal” is defined as an airwave signal, a cable-line signal, a satellite-transmitted signal, or any other signal received by an input signal port unit, wherein the input signal port unit can be an RF antenna, a cable jack, a satellite dish, and etc.

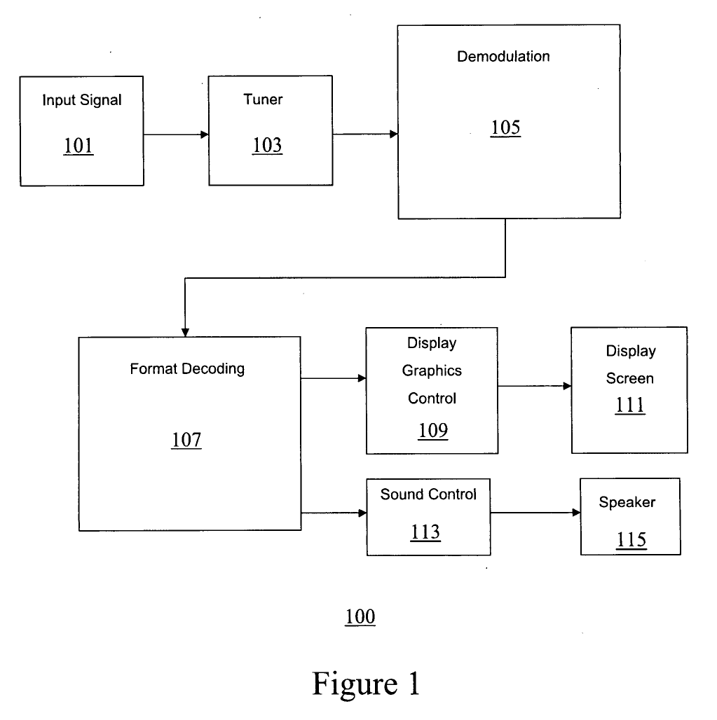

FIG. 1 shows a general signal processing flow (100) as logic blocks at a broadcasting signal receiver in accordance with one embodiment of the invention. In a preferred embodiment of the invention as shown in FIG. 1, an input signal (101) is a standard-specific broadcasting signal which is received as a radio frequency (RF) signal. The input signal (101) is fed into a tuner (103) via an input signal port.

Examples of input signals include, but are not limited to, an airwave signal, a cable-line signal, a satellite-transmitted signal, or any other signal received by an input signal port unit. For an wireless signal, the input signal port unit can simply be a wireless antenna to receive the wireless signal to a desirable gain level for subsequent tuning and demodulation. For a cable-line signal, the input signal port can be a cable jack. For a satellite-transmitted signal, the input signal port can be a satellite dish.

Continuing with FIG. 1, the tuner (103) is configured to amplify, filter, and use other conventional signal tuning methods to tune itself to a desired channel. The tuner (103) is also configured to convert an input RF signal into a desirable intermediate frequency (IF). The IF signal is then passed to a demodulation block (105) which further converts the IF signal into a base-band signal. Both analog and digital demodulation techniques exist for broadcast signal processing, but the industry trend is rapidly shifting from analog wave-based broadcasting standards to digitally-encoded and digitally-modulated broadcasting signal standards for a higher spectrum utilization, a better signal quality, and a superior signal error tolerance.

Example of digital broadcasting standards include DVB for Europe, ATSC for North America, ISDB for Japan, and DMB-TH for China. Moreover, there are digital cable and satellite broadcast standards such as QAM, DVB-C, and DVB-S.

In a typical modern digital demodulation technique, the demodulation block (105) of FIG. 1 first uses an A/D converter to digitize the IF signal to raw digital data. Then, the demodulation block (105) uses a variety of signal processing techniques to extract meaningful information from the raw digital data, detect and correct errors, and reorder data to construct standard-specific and encoded broadcasting data. Examples of standard-specific and encoded broadcasting data are MPEG2 and H.264 streams which are utilized by certain broadcasting signal standards. For a preferred embodiment of the invention, the demodulation block (105) involves a novel collaborative demodulation processing between a multi-standard-compatible dedicated processing unit and a general system resource using a high-speed data transfer interface such as PCI Express and/or USB 3.0.

Then, the standard-specific and encoded broadcasting data are fed into a format decoding block (107) of FIG. 1. In some cases of a receiver-side broadcasting signal processing, the format decoding block (107) is a software format decoder resident in a general system resource, wherein the software format decoder can be dynamically loaded to a memory unit of the general system resource whenever multimedia data decoding is required. In other cases, the format decoding block (107) is implemented in hardware. For example, a hardware decoding block can be a programmed semiconductor chip and/or a hard-coded semiconductor chip. Most format decoders are capable of detecting MPEG2, H.264, or other multimedia data formats to recover video, audio, and/or multimedia information from the standard-specific and encoded (i.e. compressed) data.

Continuing with FIG. 1, the recovered video, audio, and/or multimedia information from the format decoding block (107) is then typically passed to a display graphics control block (109) and/or a sound control block (113) in order to display and/or generate multimedia information on a display screen (111) and/or a speaker (115). Examples of the display graphics control block (109) include a PC graphic card, a specialized graphics processor, and/or a software-based graphics controller. Examples of the sound control block (113) include a PC sound card, an embedded sound controller chip, and/or a software-based sound controller.

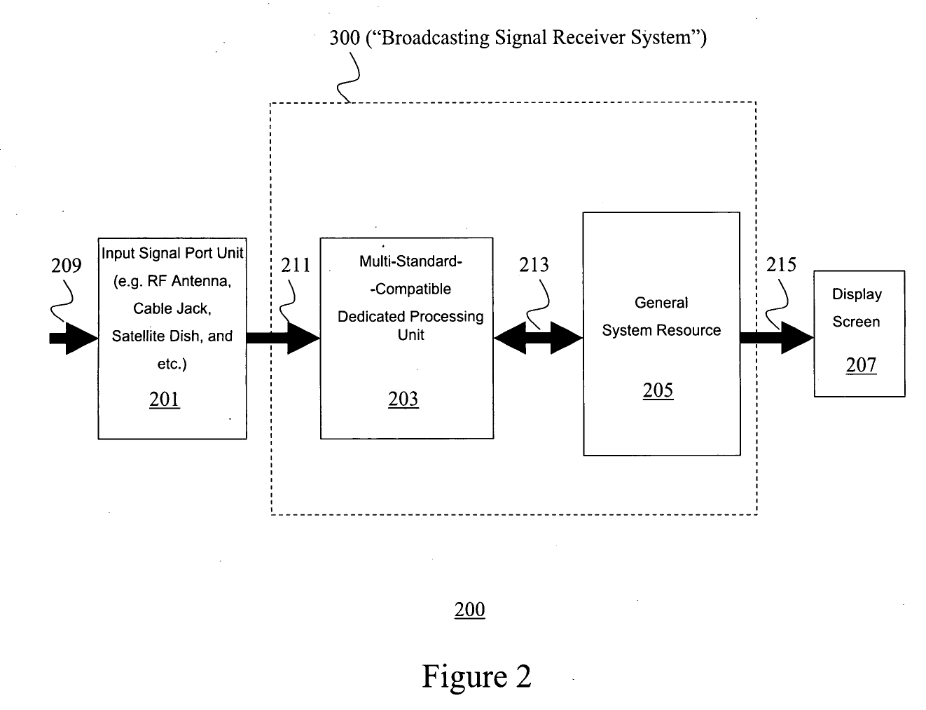

FIG. 2 shows a high-level logical conceptual configuration (200) for a broadcasting signal receiver system (300) operatively connected to an input signal port unit (201) and a display screen (207) in accordance with an embodiment of the invention. The input signal port unit (201) can be an RF antenna for an airwave signal (e.g. 209), a cable jack for a cable-line signal (e.g. 209), and/or a satellite dish for a satellite-transmitted signal (e.g. 209). The input signal port unit (201) feeds an input signal (211) to a multi-standard-compatible dedicated processing unit (203), typically as a one-way signal transfer as shown by the input signal (211).

The broadcasting signal receiver system (300) is defined as a collaborative broadcast signal processing system comprising a multi-standard-compatible dedicated processing unit (203) and a general system resource (205), wherein the collaborative broadcast signal processing system is configured to conduct at least some portion of tuner processing and/or signal demodulation.

It is important to note that one or more collaborative tuner processing and/or demodulation processing steps using a high-speed bidirectional data transfer interface (213) (e.g. PCI Express, USB3.0, and etc.) between the multi-standard-compatible dedicated processing unit (203) and the general system resource (205) are novel aspects of the invention. A novel software-based implementation of one or more tuner processing steps and/or demodulation processing steps to utilize an instruction processing unit (e.g. a CPU, a digital signal processor, and etc.) and a memory unit of the general system resource (205) in the present invention provides a cost-effective and easy-to-update broadcasting signal receiver system (300) architecture that can handle a multiple number of broadcasting signal standards flexibly.

Prior to a commercial availability of high-speed data transfer interfaces such as PCI Express and USB3.0, it would have been nearly impractical to use a data-transferring bus (i.e. due to timing and speed constraints causing massive delays) to offload at least some of the tuner processing and/or demodulation procedures to a general system resource (205). Therefore, conventional broadcasting signal receivers typically complete all of the signal tuner processing and demodulation procedures in a dedicated processing unit, after which the demodulated data are fed into a general system resource as a one-way data transfer. In such conventional broadcasting signal receivers, the general system resource typically only handles format decoding of the demodulated data processed from the dedicated processing unit. Drawbacks of the conventional one-way data transfer and a lack of collaborative tuner processing and demodulation procedures with the general system resource are significant.

One significant disadvantage is a lack of design flexibility in accommodating a multiple number of broadcasting signal standards, because most of the receiver-side broadcasting signal processing has to be completed with only a dedicated unit's resources. Accommodating a variety of broadcasting signal standards only with the dedicated processing unit's resources requires an expensive amount of on-chip storage and processing capability, which drive up the cost of manufacturing and designing the dedicated processing unit. Furthermore, implementing all types of tuner processing steps and/or demodulation processing steps solely with the dedicated processing unit causes a significant design complexity and constraint to a dynamic update of broadcasting signal standards.

In contrast, as shown in FIG. 2, one or more collaborative tuner processing and/or demodulation processing steps using a high-speed bidirectional data transfer interface (213) (e.g. PCI Express, USB3.0, and etc.) between the multi-standard-compatible dedicated processing unit (203) and the general system resource (205) as embodied in the present invention enables a flexible and programmable broadcasting signal receiver system (300) by offloading one or more tuner processing steps and/or one or more demodulation processing steps to an instruction processing unit and a memory unit of the general system resource (205). In a preferred embodiment of the invention, the general system resource (205) is configured to load a tuner processing and/or a demodulation software to a memory unit of the general system resource (205). By keeping at least a portion of tuner processing and/or demodulation procedures to be a software process which can be dynamically and cheaply loaded on-the-fly to the memory unit of the general system resource (205), the present invention can increase the ease of accommodating a variety of broadcasting signal standards at a fraction of the cost of building an equivalent broadcasting signal receiver solely on a dedicated processing unit. Furthermore, by keeping at least a portion of tuner processing and/or demodulation procedures to be a software which can be dynamically-loaded to the memory unit of the general system resource (205), the present invention can also provide an ease of dynamic update related to broadcasting signal standards, unlike a broadcasting signal receiver only implemented on a dedicated unit.

Continuing with FIG. 2, in a preferred embodiment of the invention, after all tuner processing and demodulation processing steps are completed in the broadcasting signal receiver system (300), a demodulated stream of data is now in a multimedia encoding format (e.g. MPEG2, H.264). The demodulated stream of data is subsequently decoded by a format decoder within the general system resource (205). The format decoder is typically a software capable of decoding a multiple number of multimedia encoding formats. Then, in the preferred embodiment of the invention, the decoded graphics, sound, and/or multimedia information are transmitted to a display controller and/or a sound controller within the general system resource (205) for generation of graphics (215) to a display screen (207) and/or generation of sound through a speaker.

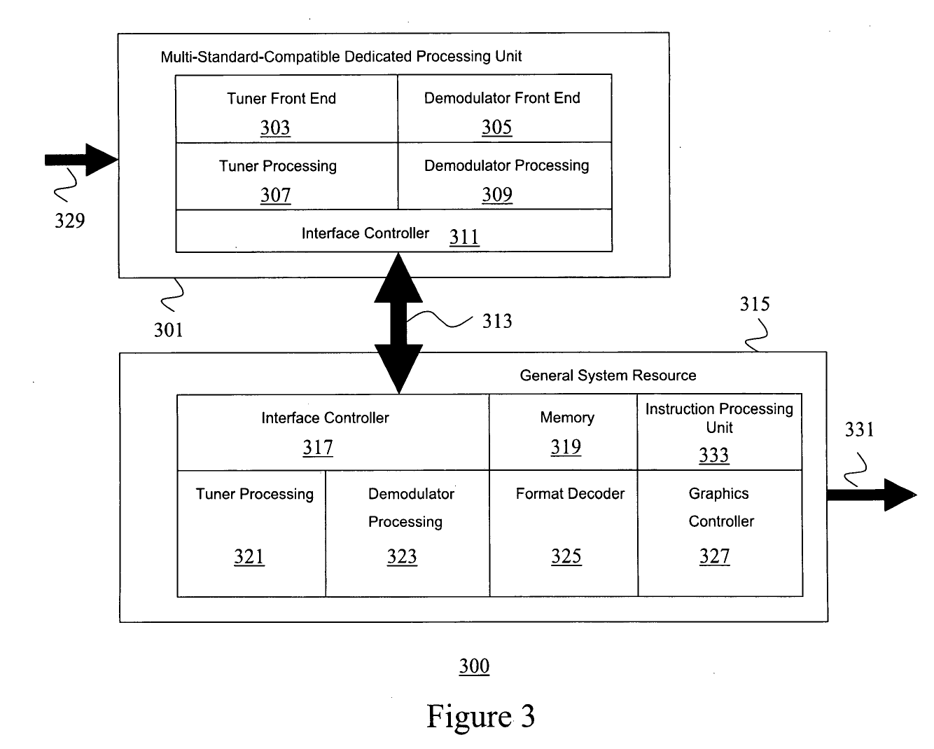

FIG. 3 shows a more detailed logical conceptual configuration (300) for a broadcasting signal receiver system (301, 313, 315) in accordance with an embodiment of the invention. In a preferred embodiment of the invention, a multi-standard-compatible dedicated processing unit (301) of the broadcasting signal receiver system (301, 313, 315) comprises a tuner front-end block (303), a dedicated processing unit-side tuner processing block (307), a demodulator front-end block (305), a dedicated processing unit-side demodulator processing block. (309), and a dedicated processing unit-side interface controller (311). The dedicated processing unit-side interface controller (311) is configured to provide a bidirectional high-speed data transfer (313) between the multi-standard-compatible dedicated processing unit (301) and a general system resource (315). In one embodiment of the invention, the dedicated processing unit-side interface controller (311) is USB 3.0-compliant and/or a PCI Express-compliant.

In the preferred embodiment of the invention, the general system resource (315) of the broadcasting signal receiver system (301, 313, 315) comprises a general system resource-side interface controller (317), a general system resource-side tuner processing block (321), a general system resource-side demodulator processing block (323), a memory unit (319), a format decoder block (325), a graphics controller block (327), and an instruction processing unit (333).

Continuing with FIG. 3, in the preferred embodiment of the invention, the tuner front-end block (303) is configured to receive an input signal (329) and trigger necessary one or more tuning functions from the dedicated processing unit-side tuner processing block (307). In most cases, the dedicated processing unit-side tuner processing block (307) operates in analog domain and is configured to perform amplification of the input signal (329), filtering of the input signal (329), tuning to a desired channel, and converting a tuned signal to an intermediate frequency (IF) signal from a raw input signal, without requiring much collaboration from the general system resource-side tuner processing block (321).

If the tuner processing only involves analog domain, then an analog-to-digital (A/D) signal conversion is typically required during demodulation after the tuner processing. In contrast, if the tuner processing block (307) itself uses digital-domain tuning (e.g. digital signal processing to perform RF to IF conversion and sending digitized data to a demodulator block (e.g. 305, 309)), then the A/D signal conversion may not be required subsequently during demodulation.

In some cases and especially in digital-domain tuner processing situations, the general system resource-side tuner processing block (321) is typically a dynamically-loaded software to the memory unit (319) of the general system resource (315) to perform various instruction executions in an instruction processing unit (333) (e.g. a CPU, a DSP, and etc.) in the general system resource (315). The general system resource-side tuner processing block (321) can be utilized to perform tuner processing-related tasks collaboratively with the dedicated processing unit-side tuner processing block (307) using the bidirectional high-speed data transfer (313) provided by the interface controllers (311, 317).

Continuing with FIG. 3, once the tuner processing is complete either by the multi-standard-compatible dedicated processing unit (301) alone or by a collaborative interaction between the multi-standard-compatible dedicated processing unit (301) and the general system resource (315), a resulting IF signal is passed to a demodulator front-end block (305) which subsequently starts demodulation steps for the IF signal using the dedicated processing unit-side demodulator processing block (309) in one embodiment of the invention.

In a preferred embodiment of the invention, a collaborative IF signal demodulation takes place between the multi-standard-compatible dedicated processing unit (301) and the general system resource (315) using the bidirectional high-speed data transfer (313). In one embodiment of the invention, the collaborative demodulation procedures are closely coupled and can take place in sequential steps between the dedicated processing unit-side demodulator processing block (309) and the general system resource-side demodulator processing block (323) via the interface controllers (311, 317) which accommodate the bidirectional high-speed data transfer (313). Examples of high-speed data transfer technologies commercially available today and viable for this application include, but are not limited to, PCI Express and USB 3.0. In a preferred embodiment of the invention, the general system resource-side demodulator processing block (323) is a demodulation software program which is dynamically-loaded to the memory unit (319) of the general system resource (315). The demodulation software program is then executed in an instruction processing unit (333) of the general system resource (315) to perform one or more signal demodulation processing steps required from the general system resource-side demodulator processing block (323).

In the preferred embodiment of the invention, one or more signal demodulation processing steps are designed to take place intentionally on the general system resource-side using the demodulation software program as the general system resource-side demodulator processing block (323) to provide a flexible demodulation architecture. The flexible demodulation architecture allows the demodulation software program on the general system resource (315) to process a variety of broadcasting signal standards flexibly and cost-effectively, compared to existing solutions which process demodulation solely in a dedicated processing unit.

Continuing with FIG. 3, completing signal demodulation steps produces a standard-specific multimedia format data stream (e.g. MPEG2, H.264). The standard-specific multimedia format data stream is then fed into a format decoder (325). In some implementations of a receiver-side broadcasting signal processing, the format decoder (325) is a software format decoder resident in a general system resource (315), wherein the software format decoder can be dynamically loaded to the memory unit (319) of the general system resource (315) whenever multimedia data decoding is required. In other cases, the format decoder (325) is implemented in hardware. For example, a hardware format decoder can be a programmed semiconductor chip and/or a hard-coded semiconductor chip. Most format decoders are capable of detecting MPEG2, H.264, or other multimedia data formats to recover video, audio, and/or multimedia information from the standard-specific and encoded (i.e. compressed) data.

Once the standard-specific multimedia format data stream is decoded, the recovered video, audio, and/or multimedia information is then typically passed to a graphics controller (327) as shown in FIG. 3 and/or a sound controller in order to display and/or generate multimedia information (331) on a display screen and/or a speaker.

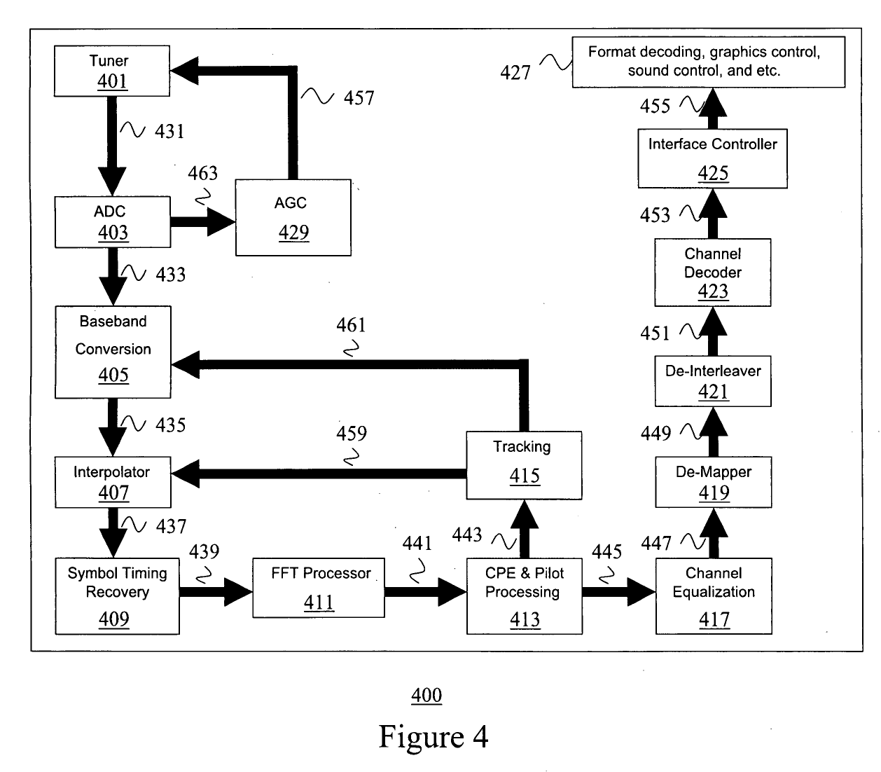

FIG. 4 shows an example of a demodulation process flow in a broadcasting signal receiver system (400) in accordance with an embodiment of the invention for the DVB broadcasting standard typically used in Europe. It should be noted that the demodulation process flow shown in FIG. 4 is merely one instance of an embodiment of the invention and this particular instance is specific to the DVB broadcasting standard. Therefore, the demodulation process flow of FIG. 4 does not limit the present invention only to this particular configuration, functional blocks, and/or algorithms. Other demodulation process flows embodying the present invention may involve different functional blocks or algorithms. For example, the ATSC broadcasting standard may involve different tracking and pilot processing algorithms from the DVB broadcasting standard.

An output signal (431) from a tuner (401) starts the demodulation process flow for the DVB broadcasting standard example shown in FIG. 4. The tuner (401) is typically configured to tune into a particular channel for a raw input signal, amplify, filter, and/or convert the raw input signal into an IF signal as the output signal (431). The output signal (431) from the tuner (401) is subsequently fed into an analog-to-digital converter (ADC) (403).

Continuing with the example of demodulation process flow for the DVB standard as shown in FIG. 4, the ADC (403) takes an analog IF signal and converts to a digital signal. The ADC (403) is necessary if the tuner (401) operates in analog domain and most tuners (e.g. 401) in the market today operate in analog domain requiring the ADC (403). However, some tuners (e.g. 401) operate in digital domain. If the tuner (401) operates in digital domain to generate a digitized IF signal, then the ADC (403) may not be necessary in the demodulation process flow for the DVB broadcasting standard example shown in FIG. 4.

An automatic gain control, or AGC (429) is typically coupled with the ADC (403) and the tuner (401) as a feedback loop (i.e. 431, 463, 457) to limit undesirable variations in the output signal (431) of the tuner (401). Without the AGC (429), the strength of the output signal (431) from the tuner (401) can vary depending on an input signal strength and a constant output level for the output signal (431) is difficult to maintain.

A baseband conversion block (405) converts an IF signal to a baseband signal. An interpolator (407) attempts to synchronize a local clock of the broadcasting signal receiver system (400) with a clock of a broadcasting signal transmitter, wherein the local clock is typically asynchronous. Because there are data transmitting/assembly rate and/or clock frequency (i.e. for sampling data) differences between the broadcasting signal transmitter and the broadcasting signal receiver system (400), an interpolator (407) is used to estimate and get as close as possible to the broadcasting signal transmitter's data transmitting/assembly rate and/or clock frequency for the broadcasting signal receiver system (400). The baseband conversion block (405) and the interpolator (407) work synergistically to convert an incoming IF signal (e.g. from 433 if the ADC (403) is necessary or from 431 if the ADC (403) is unnecessary) to a baseband signal (e.g. 435, 437).

Continuing with the example of demodulation process flow for the DVB standard as shown in FIG. 4, a symbol timing recovery block (409) performs a time-domain synchronization with symbols embedded in an incoming signal (437) to find the boundaries of each symbol. The time-domain synchronization is performed to find where at least a portion of wanted data is located before an FFT can be performed on the wanted data. Then, with a signal (439) from the symbol timing recovery block (409), a FFT processor (411) performs a Fast Fourier Transform (FFT) to convert a time-domain signal (e.g. 439) to a frequency-domain (e.g. 441) signal.

A common phase error (CPE) correction & pilot processing block (413) and a tracking block (415) are configured to form a feedback loop (i.e. 443, 459, 461, 435, 437, 439, and 441) with the baseband conversion block (405), the interpolator (407), the symbol timing recovery block (409) and the FFT processor (411) to assist the broadcasting receiver system adjust its clock rate for a desirable synchronization with a broadcasting signal transmitter. The broadcasting signal transmitter typically inserts one or more pilot signals into a transmitted signal to assist the broadcasting signal receiver system (400) to decode and/or synchronize with the transmitted signal. Based on the one or more pilot signals, the CPE & pilot processing block (413) can determine types and/or magnitudes of adjustment necessary to allow the broadcasting signal receiver system (400) to synchronize with the broadcasting signal transmitter correctly. The tracking block (415) is configured to make necessary adjustments to synchronize with the broadcasting signal transmitter based on information gathered and processed in the feedback loop (i.e. 443, 459, 461, 435, 437, 439, and 441).

Continuing with the example of demodulation process flow for the DVB standard as shown in FIG. 4, a channel equalization block (417) uses known pilot signal information to correct at least some signal distortion and/or degradation issues caused in a channel during a signal transmission. More specifically, a “channel” is a transmitted signal's path from a broadcasting signal transmitter to the broadcasting signal receiver system (400). A medium of channel depends on a types of signal transmission. For a wireless RF frequency transmission, the medium of channel may be air. For a cable-line transmission, the medium of channel may be copper cables. For an optical signal transmission, the medium of channel may be fiber optics. The medium of channel is often influenced by environmental factors which degrades signal transmission quality. For example, one or more objects blocking a line-of-sight path between the broadcasting signal transmitter and the broadcasting signal receiver system (400) for the wireless RF frequency transmission can create attenuation, undesirable amplitude changes, and/or other signal distortions and/or degradation issues which need to be corrected at the broadcasting signal receiver system (400). Using the known pilot signal information received via an input signal (445) to the channel equalization block (417), the channel equalization block is able to correct at least some distortion and/or degradation issues before sending the corrected signal (447) to a de-mapper block (419).

The de-mapper block (419) takes the corrected signal (447) from the channel equalization block (417) and decodes a few transmitter-encoded bits. Then, a de-interleaver (421) takes an output signal (449) from the de-mapper block (419) to reassemble data which was intentionally scrambled and/or interleaved at a broadcasting signal transmitter. The intentionally-scrambled and/or interleaved data spreads out the effects of channel transmission errors to reduce chances of a burst error and/or a fatal data reception error at the broadcasting signal receiver system (400).

Continuing with the example of demodulation process flow for the DVB standard as shown in FIG. 4, a channel decoder (423) takes an input signal (451) from the de-interleaver (421) and performs a forward error correction (FEC) using techniques such as Viterbi decoding and/or Reed Solomon decoding. The channel decoder (423) is also configured to conduct packet synchronization for MPEG-related data formats.

An output signal (453) from the channel decoder (423) is now a fully demodulated signal representing a standard-specific multimedia data format such as MPEG2 or H.264. The output signal (453) represents the completion of the example of demodulation process flow for the DVB standard for FIG. 4. The output signal (453) then can be transferred (455) to a general system resource (427) via an interface controller (425) for format decoding, graphics control, sound control, and/or other tasks needed for generation of graphics, sound, and/or multimedia

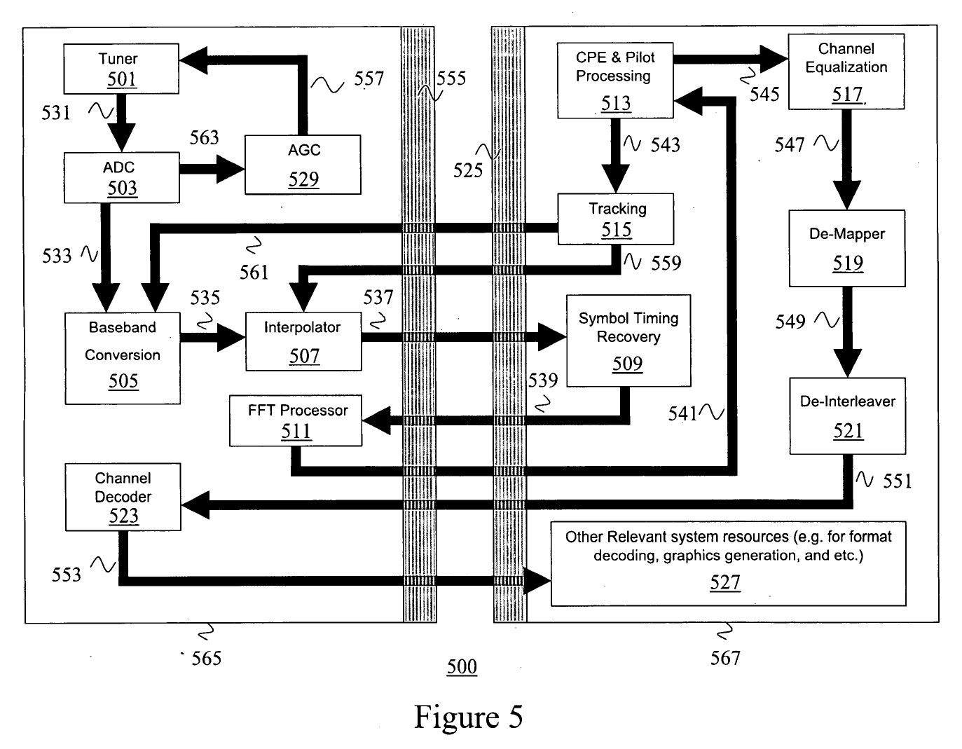

FIG. 5 shows an example of a collaborative broadcasting signal demodulation by a multi-standard-compatible dedicated processing unit (565) and a general system resource (567) operating a programmable demodulation processing software which runs on the general system resource's instruction processing unit and a memory unit, in accordance with an embodiment of the invention. This example is based on the same demodulation process flow for the DVB standard as shown in FIG. 4, but with the collaborative broadcasting signal demodulation graphically illustrated by signal data processing flows between the multi-standard-compatible dedicated processing unit (565) and the general system resource (567). The multi-standard-compatible dedicated processing unit (565), the general system resource (567), and high-speed data interface controllers (525, 555) comprise a broadcasting signal receiver system (500) in one embodiment of the invention.

In a preferred embodiment of the invention, an output signal (531) from a tuner (501) on the multi-standard-compatible dedicated processing unit (565) starts the collaborative broadcasting signal demodulation process flow for the DVB standard example shown in FIG. 5. The tuner (501) is typically configured to tune into a particular channel for a raw input signal, amplify, filter, and/or convert the raw input signal into an IF signal as the output signal (531). The output signal (531) from the tuner (501) is subsequently fed into an analog-to-digital converter (ADC) (503).

Continuing with the collaborative broadcasting signal demodulation process flow for the DVB standard example shown in FIG. 5, the ADC (503) takes an analog IF signal and converts to a digital signal. The ADC (503) is necessary if the tuner (501) operates in analog domain and most tuners (e.g. 501) in the market today operate in analog domain requiring the ADC (503). However, some tuners (e.g. 501) operate in digital domain. If the tuner (501) operates in digital domain to generate a digitized IF signal, then the ADC (503) may not be necessary in the demodulation process flow for the DVB broadcasting standard example shown in FIG. 4.

An automatic gain control, or AGC (529) is typically coupled with the ADC (503) and the tuner (501) as a feedback loop (i.e. 531, 563, 557) to limit undesirable variations in the output signal (531) of the tuner (501). Without the AGC (529), the strength of the output signal (531) from the tuner (501) can vary depending on an input signal strength and a constant output level for the output signal (531) is difficult to maintain.

In the preferred embodiment of the invention, a baseband conversion block (505) converts an IF signal to a baseband signal. An interpolator (507) attempts to synchronize a local clock of the broadcasting signal receiver system (500) with a clock of a broadcasting signal transmitter, wherein the local clock is typically asynchronous. Because there are data transmitting/assembly rate and/or clock frequency (i.e. for sampling data) differences between the broadcasting signal transmitter and the broadcasting signal receiver system (500), an interpolator (507) is used to estimate and get as close as possible to the broadcasting signal transmitter's data transmitting/assembly rate and/or clock frequency for the broadcasting signal receiver system (500). The baseband conversion block (505) and the interpolator (507) work synergistically to convert an incoming IF signal (e.g. from 533 if the ADC (503) is necessary or from 531 if the ADC (503) is unnecessary) to a baseband signal (e.g. 535, 537).

Continuing with the collaborative broadcasting signal demodulation process flow for the DVB standard example shown in FIG. 5, it is important to note that several blocks of the signal demodulation process flow are allocated to the general system resource. In one embodiment of the invention, these general system resource-side blocks, which were also defined equivalently and more abstractly as the “general system resource-side demodulator processing block (323)” in FIG. 3, can include a symbol timing recovery block (509), a CPE & pilot processing block (513), a tracking block (515), a channel equalization block (517), a de-mapper block (519), and a de-interleaver block (521). Functionally, these general system-resource-side blocks (e.g. 509, 513, 515, 517, 519, 521) are largely equivalent to identically-named blocks already described in FIG. 4. The general system resource (567) also includes other relevant system resources (527) which may include a format decoding software, a graphics controller, a sound controller, and/or other relevant functions to the broadcasting signal receiver system (500).

In a preferred embodiment of the invention, the general system resource-side blocks (e.g. 509, 513, 515, 517, 519, 521) communicate with some dedicated processing unit-side blocks (e.g. 505, 507, 511, 523) via high-speed data transfer interfaces (525, 555). Examples of high-speed data transfer interfaces include, but are not limited to, PCI Express and USB 3.0. It is noted that dedicated processing unit-side blocks (e.g. 503, 529, 505, 507, 511, 523) of FIG. 5 for demodulation processing steps are equivalently and more abstractly defined as the “demodulator front end (305)” and the “dedicated processing unit-side demodulator processing block (309)” in FIG. 3.

The allocation of several functional blocks (e.g. 509, 513, 515, 517, 519, 521) to the general system resource (567) can offload many broadcasting signal standard-specific demodulation processing steps to a demodulator software utilizing an instruction processing unit and a memory unit of the general system resource (567), instead of relying on more costly on-chip resources of the multi-standard-compatible dedicated processing unit (565). Because some high-speed data transfer interfaces (e.g. 525, 555) which became commercially available recently (e.g. PCI Express, USB 3.0) can transfer data fast enough to ignore potential latency issues during collaborative broadcasting signal demodulation processes between the multi-standard-compatible dedicated processing unit and the general system resource (567), the present invention provides significant design flexibility, ease of update, and cost advantages to conventional standalone dedicated processing unit broadcasting signal receivers.

Continuing with the collaborative broadcasting signal demodulation process flow for the DVB standard example shown in FIG. 5, a symbol timing recovery block (509) in the general system resource (567) receives an incoming signal (537) from the interpolator (507) via the high-speed data transfer interface controllers (525, 555) and performs a time-domain synchronization to find the boundaries of each symbol embedded in the incoming signal (537). The time-domain synchronization is performed to find where at least a portion of wanted data is located before an FFT can be performed on the wanted data. Then, an output signal (539) from the symbol timing recovery block (509) is transmitted from the general system resource (567) to a FFT processor (511) in the multi-standard-compatible dedicated processing unit (565) via the high-speed data transfer interface controllers (525, 555). Subsequently, the FFT processor (511) performs a Fast Fourier Transform (FFT) to convert a time-domain signal (e.g. 539) to a frequency-domain (e.g. 541) signal.

An output signal (541) from the FFT processor (511) is then transmitted to a common phase error (CPE) correction & pilot processing block (513) in the general system resource (567) via the high-speed data transfer interface controllers (525, 555). The CPE correction & pilot processing block (513) and a tracking block (515) are configured to form a feedback loop (i.e. 543, 559, 561, 535, 537, 539, and 541) with the baseband conversion block (505), the interpolator (507), the symbol timing recovery block (509) and the FFT processor (511) to assist the broadcasting receiver system adjust its clock rate for a desirable synchronization with a broadcasting signal transmitter. The broadcasting signal transmitter typically inserts one or more pilot signals into a transmitted signal to assist the broadcasting signal receiver system (500) to decode and/or synchronize with the transmitted signal. Based on the one or more pilot signals, the CPE & pilot processing block (513) can determine types and/or magnitudes of adjustment necessary to allow the broadcasting signal receiver system (500) to synchronize with the broadcasting signal transmitter correctly. The tracking block (515) is configured to make necessary adjustments to synchronize with the broadcasting signal transmitter based on information gathered and processed in the feedback loop (i.e. 543, 559, 561, 535, 537, 539, and 541).

Continuing with the collaborative broadcasting signal demodulation process flow for the DVB standard example shown in FIG. 5, a channel equalization block (517) uses known pilot signal information to correct at least some signal distortion and/or degradation issues caused in a channel during a signal transmission. More specifically, a “channel” is a transmitted signal's path from a broadcasting signal transmitter to the broadcasting signal receiver system (500). A medium of channel depends on a types of signal transmission. For a wireless RF frequency transmission, the medium of channel may be air. For a cable-line transmission, the medium of channel may be copper cables. For an optical signal transmission, the medium of channel may be fiber optics. The medium of channel is often influenced by environmental factors which degrades signal transmission quality. For example, one or more objects blocking a line-of-sight path between the broadcasting signal transmitter and the broadcasting signal receiver system (500) for the wireless RF frequency transmission can create attenuation, undesirable amplitude changes, and/or other signal distortions and/or degradation issues which need to be corrected at the broadcasting signal receiver system (500). Using the known pilot signal information received via an input signal (545) to the channel equalization block (517), the channel equalization block is able to correct at least some distortion and/or degradation issues before sending the corrected signal (547) to a de-mapper block (519).

The de-mapper block (519) takes the corrected signal (547) from the channel equalization block (517) and decodes a few transmitter-encoded bits. Then, a de-interleaver (521) takes an output signal (549) from the de-mapper block (519) to reassemble data which was intentionally scrambled and/or interleaved at a broadcasting signal transmitter. The intentionally-scrambled and/or interleaved data spreads out the effects of channel transmission errors to reduce chances of a burst and/or a fatal data reception error at the broadcasting signal receiver system (500).

Continuing with the collaborative broadcasting signal demodulation process flow for the DVB standard example shown in FIG. 5, a channel decoder (523) in the multi-standard-compatible dedicated unit takes an input signal (551) from the de-interleaver (521) via the high-speed data transfer interface controllers (525, 555), and performs a forward error correction (FEC) using techniques such as Viterbi decoding and/or Reed Solomon decoding. The channel decoder (523) is also configured to conduct packet synchronization for MPEG-related data formats.

An output signal (553) from the channel decoder (523) is now a fully demodulated signal representing a standard-specific multimedia data format such as MPEG2 or H.264. The output signal (553) then can be transferred to a general system resource (527) via the high-speed data transfer interface controllers (525, 555) for format decoding, graphics control, sound control, and/or other tasks needed for generation of graphics, sound, and/or multimedia.

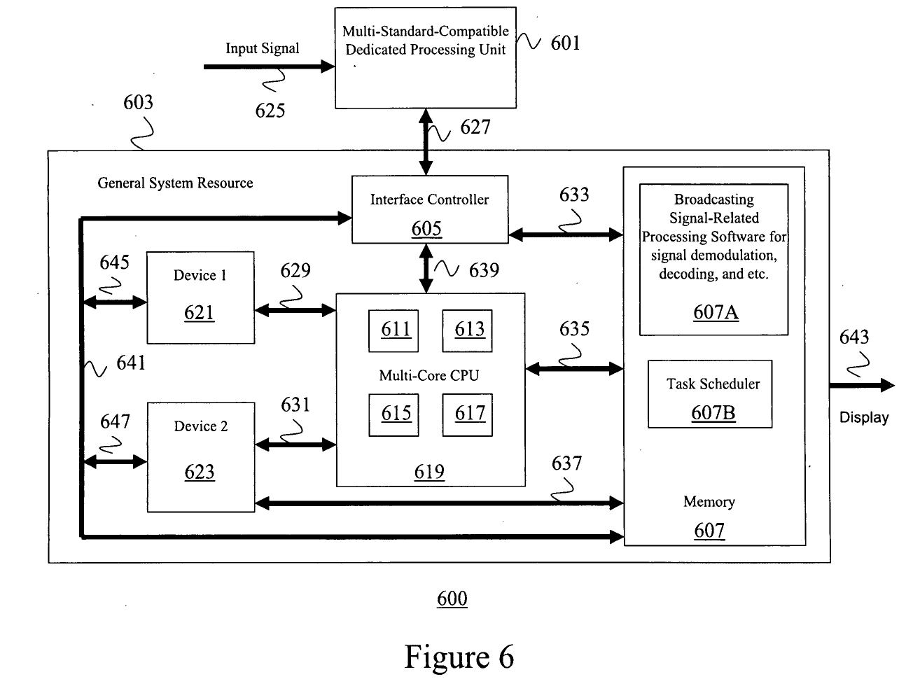

FIG. 6 shows an example of a broadcasting signal receiver system (600) using a multi-standard-compatible dedicated processing unit (601) operatively connected to a general system resource (603) containing a multi-core CPU (619) (i.e. a type of a multi-core instruction processing unit) for collaborative broadcasting signal demodulation in accordance with an embodiment of the invention.

In one embodiment of the invention, the general system resource (603) contains a multi-core CPU (619) with four cores (i.e. 611, 613, 615, 617), wherein each core is configured to execute instructions and process data in parallel (i.e. independently) from other cores. The multi-core CPU (619) is operatively connected (639) to a high-speed data transfer interface controller (605), which is operatively connected (627) to the multi-standard-compatible dedicated processing unit (601). Optionally, the high-speed data transfer interface controller (605) is also operatively connected (633) to a memory unit (607). In a preferred embodiment of the invention, the broadcasting signal receiver system (600) receives an input signal (625) with the multi-standard-compatible dedicated processing unit (601).

Continuing with FIG. 6, the multi-core CPU (619) is also operatively connected (635) to the memory unit (607), which contains a broadcasting signal-related processing software (607A) for signal demodulation, format decoding, and/or other relevant functions for the broadcasting signal receiver system (600). The memory unit (607) also contains a task scheduler (607B) which is configured to assign and/or manage tasks to each core (i.e. 611, 613, 615, 617) of the multi-core CPU (619). The general system resource (603) may also have other devices (e.g. 621, 623) such as a hard drive, a graphics card, and/or other peripherals which may be operatively connected (e.g. 629, 631, 637, 641, 645, 647) to the multi-core CPU (619), the memory unit (607), and/or the high-speed data transfer interface controller (605).

In a computer system and/or an electronic system with a central processing unit (e.g. a microprocessor, a microcontroller, and etc.), using a multi-core CPU (e.g. 619) is becoming more mainstream. The present invention may optionally utilize a multi-core CPU design and the task scheduler (607B) in the general system resource (603) to execute some tuner processing steps and/or some demodulation processing steps in parallel to speed up tuner processing and/or demodulation processing for the broadcasting receiver system (600).

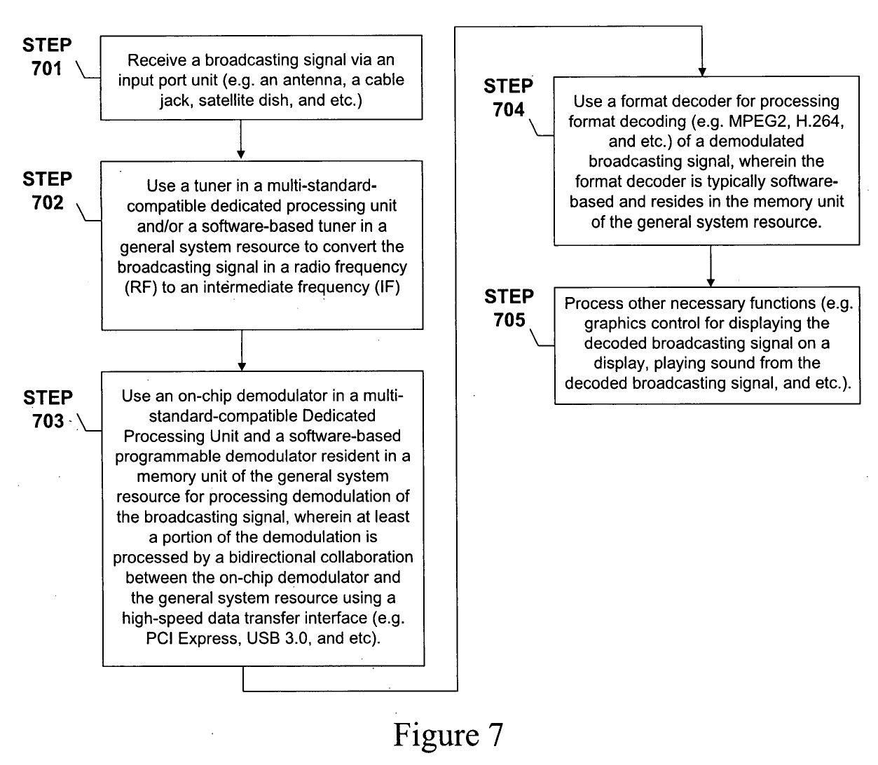

FIG. 7 shows a collaborative broadcasting signal processing method by a multi-standard-compatible dedicated processing unit and a general system resource in accordance with an embodiment of the invention. In STEP 701, a broadcasting signal receiver system comprising the multi-standard-compatible dedicated processing unit and the general system resource receives a broadcasting signal via an input port unit. Examples of input port unit includes an antenna, a cable jack, and a satellite dish.

Then, in STEP 702, the broadcasting signal receiver system uses a tuner in the multi-standard-compatible dedicated processing unit and/or a software-based tuner in the general system resource to convert the broadcasting signal in a radio frequency (RF) to an intermediate frequency (IF). Subsequently, the broadcasting signal receiver system uses an on-chip demodulator in a multi-standard-compatible dedicated processing unit and a software-based programmable demodulator which is resident in a memory unit of the general system resource for processing demodulation of the broadcasting signal in STEP 703. In one embodiment of the invention, at least a portion of the demodulation is processed by a bidirectional collaboration between the on-chip demodulator and the general system resource using a high-speed data transfer interface (e.g. PCI Express, USB 3.0, and etc.).

Then, in STEP 704, the broadcasting signal receiver system uses a format decoder for processing format decoding (e.g. MPEG2, H.264, and etc.) of a demodulated broadcasting signal, wherein the format decoder is typically software-based and resides in the memory unit of the general system interface. In STEP 705, the broadcasting signal receiver system processes other necessary functions such as instructing a graphics controller for displaying the decoded broadcasting signal on a display and/or instructing a sound controller to play sound from the decoded broadcasting signal.

The present invention provides several key benefits to broadcasting receiver designs. First, the novel broadcasting signal receiver system as described for the present invention provides a method and an apparatus for processing multiple broadcasting signal standards in a single broadcasting signal receiver system by offloading at least some standard-specific tuning process and/or at least some standard-specific demodulation steps to a general system resource utilizing a software running on the general system resource's instruction processing unit.

Second, the novel broadcasting signal receiver system as described for the present invention utilizes a collaborative broadcasting signal processing by a multi-standard-compatible dedicated processing unit and a general system resource to create a cost-effective and easily-updatable broadcasting signal receiver system which can handle a multiple number of broadcasting signal standards flexibly.

Furthermore, the present invention also provides a receiver-side collaborative broadcasting signal processing method using a multi-standard-compatible dedicated processing unit and a general system resource as a coherent collaborative and synergistic broadcasting signal receiver system, wherein the general system resource utilizes a multi-core instruction processing unit (e.g. a multi-core CPU, a multi-core digital signal processor, and etc.) or a multiple number of instruction processing units (e.g. a multiple number of CPU's, a multiple number of digital signal processors, and/or etc.) to pipeline and/or parallel-process broadcasting signal-related tasks.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A broadcasting signal receiver system configured to accommodate a multiple number of broadcasting signal standards, the broadcasting signal receiver system comprising:
a multi-standard-compatible dedicated processing unit configured to process one or more tuner processing steps and/or one or more demodulation processing steps for an input signal from an input signal port unit;
a general system resource containing a demodulation processing software configured to be loaded to a memory unit in the general system resource and configured to be executed on an instruction processing unit of the general system resource, wherein the demodulation processing software operating in the general system resource is configured to process at least one collaborative demodulation processing step among the one or more demodulation processing steps with the multi-standard-compatible dedicated processing unit via a high-speed data transfer interface; and
the high-speed data transfer interface with a bidirectional data transfer speed sufficient to accommodate the at least one collaborative demodulation processing step between the multi-standard-compatible dedicated processing unit and the general system resource without causing a bottleneck delay in the one or more demodulation processing steps.

2. The broadcasting signal receiver system of claim 1, wherein the demodulation processing software in the general system resource is designed to provide a flexible, programmable, and cost-effective architecture to the broadcasting signal receiver system by making at least some broadcasting signal standard-specific processing as a software task in the general system resource, instead of putting all burdens of broadcasting signal standard-specific processing as on-chip-only tasks in the multi-standard-compatible dedicated processing unit.

3. The broadcasting signal receiver system of claim 1, further comprising a tuner processing software configured to be loaded to the memory unit in the general system resource and configured to be executed on the instruction processing unit of the general system resource, wherein the tuner processing software operating in the general system resource is configured to process at least one collaborative tuner processing step among the one or more tuner processing steps with the multi-standard-compatible dedicated processing unit via the high-speed data transfer interface.

4. The broadcasting signal receiver system of claim 1, wherein the instruction processing unit of the general system resource is a multi-core CPU configured to process the at least one collaborative demodulation processing step in a core of the multi-core CPU, while another core of the multi-core CPU executes other broadcasting signal receiver system-related tasks simultaneously.

5. The broadcasting signal receiver system of claim 3, wherein the tuner processing software operating in the general system resource acts at least partially as a digital tuner configured to generate a digitized intermediate frequency (IF) signal in collaboration with the multi-standard-compatible dedicated processing unit via the high-speed data transfer interface.

6. The broadcasting signal receiver system of claim 1, further comprising a format decoder software or a format decoder hardware configured to decode standard-specific multimedia data format, wherein the standard-specific multimedia data is extracted after a completion of the one or more demodulation processing steps.

7. The broadcasting signal receiver system of claim 6, wherein the format decoder software is operating in the general system resource and is configured to decode at least MPEG2 and/or H.264 formats.

8. The broadcasting signal receiver system of claim 1, wherein the high-speed data transfer interface is either a PCI Express or a USB 3.0 interface.

9. A broadcasting signal receiver system configured to accommodate a multiple number of broadcasting signal standards, the broadcasting signal receiver system comprising:
a multi-standard-compatible dedicated processing unit configured to process one or more tuner processing steps and/or one or more demodulation processing steps for an input signal from an input signal port unit;
a general system resource containing a demodulation processing software configured to be loaded to a memory unit in the general system resource and configured to be executed on an instruction processing unit of the general system resource, wherein the demodulation processing software operating in the general system resource is configured to process at least one collaborative demodulation processing step among the one or more demodulation processing steps with the multi-standard-compatible dedicated processing unit via a high-speed data transfer interface;
a tuner processing software configured to be loaded to the memory unit in the general system resource and configured to be executed on the instruction processing unit of the general system resource, wherein the tuner processing software operating in the general system resource is configured to process at least one collaborative tuner processing step among the one or more tuner processing steps with the multi-standard-compatible dedicated processing unit via the high-speed data transfer interface; and
the high-speed data transfer interface with a bidirectional data transfer speed sufficient to accommodate the at least one collaborative demodulation processing step and/or the at least one collaborative tuner processing step between the multi-standard-compatible dedicated processing unit and the general system resource without causing a bottleneck delay in the one or more demodulation processing steps.

10. The broadcasting signal receiver system of claim 9, wherein the demodulation processing software in the general system resource is designed to provide a flexible, programmable, and cost-effective architecture to the broadcasting signal receiver system by making at least some broadcasting signal standard-specific processing as a software task in the general system resource, instead of putting all burdens of broadcasting signal standard-specific processing as on-chip-only tasks in the multi-standard-compatible dedicated processing unit.

11. The broadcasting signal receiver system of claim 9, wherein the instruction processing unit of the general system resource is a multi-core CPU configured to process the at least one collaborative demodulation processing step in a core of the multi-core CPU, while another core of the multi-core CPU executes other broadcasting signal receiver system-related tasks simultaneously.

12. The broadcasting signal receiver system of claim 9, wherein the tuner processing software operating in the general system resource acts at least partially as a digital tuner configured to generate a digitized intermediate frequency (IF) signal in collaboration with the multi-standard-compatible dedicated processing unit via the high-speed data transfer interface.

13. The broadcasting signal receiver system of claim 9, further comprising a format decoder software configured to decode standard-specific multimedia data format, wherein the standard-specific multimedia data is extracted after a completion of the one or more demodulation processing steps.

14. The broadcasting signal receiver system of claim 13, wherein the format decoder software is operating in the general system resource and is configured to decode at least MPEG2 and/or H.264 formats.

15. The broadcasting signal receiver system of claim 9, wherein the high-speed data transfer interface is either a PCI Express or a USB 3.0 interface.

16. A method for collaborative broadcasting signal processing by a broadcasting signal receiver system comprising a multi-standard-compatible dedicated processing unit and a general system resource, the method comprising:
receiving a broadcasting signal via an input port unit of the broadcasting signal receiver system;
using a tuner in the multi-standard-compatible dedicated processing unit and/or a software-based tuner in the general system resource to convert the broadcasting signal from a radio frequency (RF) to an intermediate frequency (IF); and
using an on-chip demodulator in the multi-standard-compatible dedicated processing unit and/or a software-based programmable demodulator resident in a memory unit of the general system resource for processing demodulation of the broadcasting signal, wherein one or more demodulation steps are processed by a bidirectional collaboration between the on-chip demodulator and the general system resource using a high-speed data transfer interface.

17. The method of claim 16, further comprising a step of using a format decoder for processing format decoding of a demodulated broadcasting signal, wherein the format decoder is typically software-based and configured to reside in the memory unit of the general system resource.

18. The method of claim 17, further comprising a step of processing other necessary functions related to the broadcast signal receiver system, wherein the other necessary functions may include instructing a graphics controller and/or a sound controller to display graphics and/or play sound based on decoded data from the format decoder.

19. The method of claim 17, wherein the format decoder is configured to decode at least MPEG2 and/or H.264 formats.

20. The method of claim 16, wherein the high-speed data transfer interface is either a PCI Express or a USB 3.0 interface.
